(19) United States
(12) Patent Application Publication
(10) Pub. No.: US 2009/0015175 A1
(43) Pub. Date: Jan. 15, 2009

(54) Brightness control system for LED lighting devices

(75) Inventor: Chinn-Chann Chiang, Hsi-Chih City (TW)

Correspondence Address: BACON & THOMAS, PLLC, 625 SLATERS LANE, FOURTH FLOOR, ALEXANDRIA, VA, 22314-1176, US

(73) Assignee: DIGITEK Technology Co., Ltd., Hsi-Chih City (TW)

(21) Appl. No.: 11/826,233

(22) Filed: Jul. 13, 2007

(51) Int. Cl. H05B 33/02; H01J 61/00

(52) U.S. Cl. 315/291

(57) ABSTRACT

The present invention provides a brightness remote control system for LED lighting device. There are two control modes, namely automatic mode and manual mode. At automatic mode, the brightness of the LED lighting device changes as the brightness of the environment changes to maintain preset constant brightness. At manual mode, the brightness of the LED lighting device can be changed instantaneously or at preset time or times.

### FIELD OF THE INVENTION

The present invention relates to a brightness control system for LED lighting devices, and more particularly to a brightness control system that can remotely and manually or automatically control the brightness of the LED lighting device.

### BACKGROUND OF THE INVENTION

LED lighting devices are becoming popular and practical. Conventional lighting devices such as incandescent lamp, fluorescent lamp and high intensity discharge lamp not only consume too much electricity by the lighting devices but also raise the surrounding temperature due to high heat dissipation that indirectly increase air condition and refrigeration load. In addition to power consumption problem, environmental contamination caused by conventional lighting devices has drawn big attention worldwide. This is one of the reasons that the conventional lighting devices are phasing away by low in many places.

One can design an LED lighting device that complying with environmental requirement. More importantly, LED lighting device is easy to adjust its brightness by adjusting DC voltage to LED lighting device. When LED lighting devices become more popular, convenient adjustment on their brightness also becomes more urgent. There are many lighting control devices. A timer for automatic switching on and off is one of the oldest devices for energy saving purpose. Motion detectors by air or infrared are also used for automatic switching on and off the lighting. A dimmer to dim brightness is a common device for adjusting the brightness that, among others, can also serve for energy saving purpose. All of these control devices have their own merit, however they are confined in their specific applications. For a fluorescent light unless dimmable ballast is used it is difficulty to dim the brightness. Dimmable ballast is not only expensive but also impractical.

It is expected that most of the lighting system will be replaced with LED lighting devices in the near future. A brightness control device for LED lighting devices is urgently needed.

### SUMMARY OF THE INVENTION

The present invention provides a brightness control system for LED lighting device that can remotely and manually or automatically control the brightness of the LED lighting device. This device consists of 5 parts, namely, infrared controller, infrared receiver, brightness sensor, brightness controller, and DC voltage controller. The infrared controller is for setting parameter and sending the parameter information to the infrared receiver. The infrared receiver transfers the parameter information to the brightness controller. The brightness sensor senses brightness at the place where the brightness sensor is placed and sends the brightness information to the brightness controller. The DC voltage controller receives DC input voltage from DC power supplier and sends out DC voltage controlled by the brightness controller. For automatic brightness control, the brightness controller will send a signal to the voltage controller to adjust the output voltage according to the brightness data received from the brightness sensor and the parameter information from the infrared controller through the infrared receiver. For manual control, the brightness controller will send a signal to control the output voltage to the LED lighting device according only to the manual setting parameter from the infrared controller.

### BRIEF DESCRIPTION OF THE DRAWINGS

FIG. 1 shows the block diagram of the brightness control system.

FIG. 2 shows the schematic circuit diagram of the infrared controller.

FIG. 3 shows the schematic circuit diagram of infrared receiver, brightness sensor and brightness controller.

FIG. 4 shows the schematic circuit diagram of DC voltage controller.

### DETAILED DESCRIPTION OF THE INVENTION

DC current powers LED lighting device. An AC/DC converter is used to convert AC power to DC power with DC voltage needed for the LED lighting device. The DC voltage needed for the LED lighting device in each series connection circuit is the total sum of the voltages needed for each LED and other components on the circuit. Lowering the voltage to LED lighting device will lower the voltage to each LED. The brightness of each LED therefore will be dimmed since the brightness of LED depends on the voltage to the LED. An LED lighting device can have a built-in dimmer to lower the DC voltage to the LEDs. This is a common practice in LED brightness control. However, it is inconvenience to adjust a dimmer on the LED lighting device while the LED lighting device is at far reaching place. It is more desirable to control the brightness remotely.

For some applications, the LED lightings are installed in an environment that other light such as outdoor light is available. In this case when the outdoor light is brighter, one can dimmer the LED to the extent that it maintains the needed brightness. By doing so one can have additional energy saving. On the other hand, when the outdoor brightness is dimmer one needs more light from LED lighting. It is therefore desirable to have an automatic adjustment mechanism to maintain proper brightness for energy saving purpose.

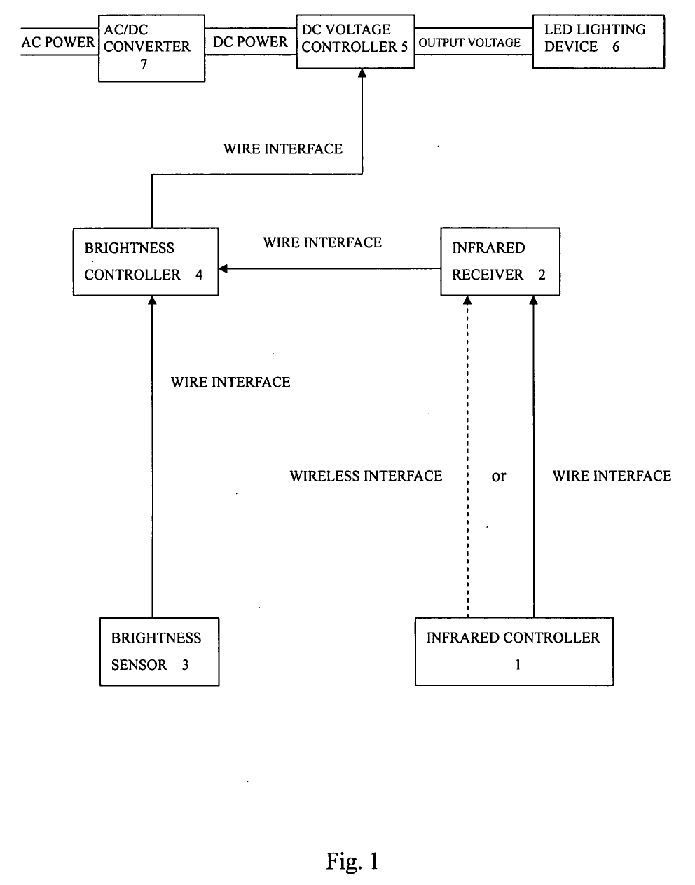

In this invention the brightness control system, as shown in FIG. 1, includes infrared controller 1, infrared receiver 2, brightness sensor 3, brightness controller 4, and DC voltage controller 5. The brightness of the LED lighting device 6 can be controlled automatically or manually. An AC/DC converter 7 is used to convert the AC power to DC power as shown in FIG. 1.

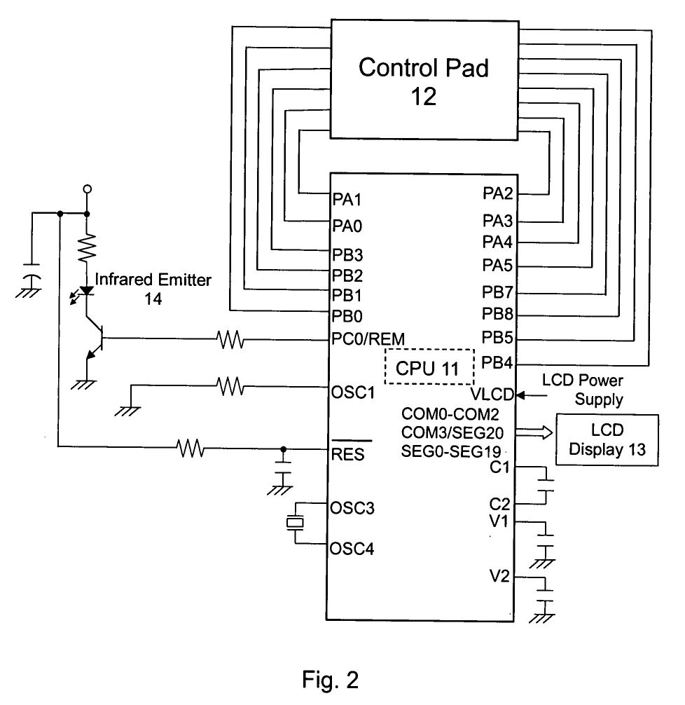

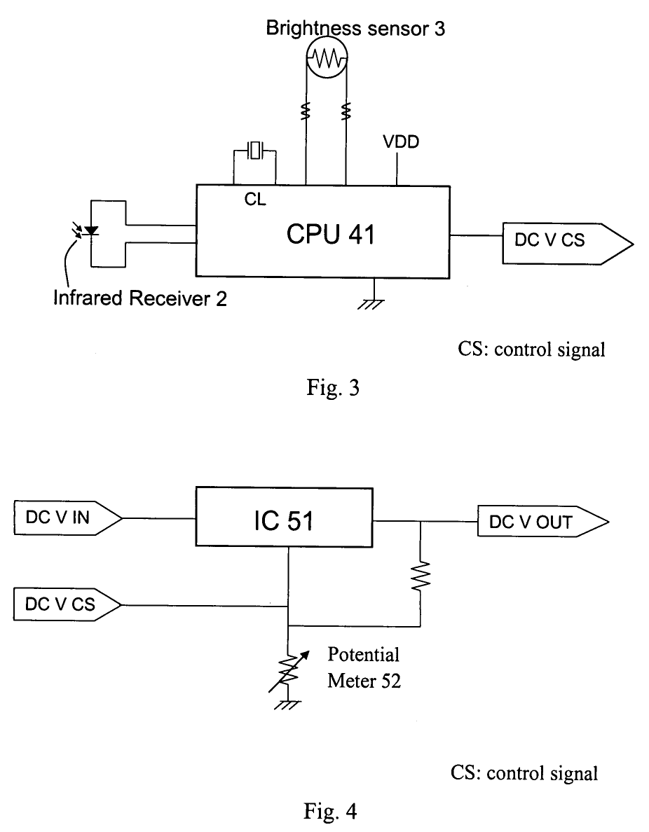

As shown in FIG. 2, the infrared controller 1 mainly consists of a CPU 11, a control pad 12, an LCD display 13, and an infrared emitter 14. The parameter information is set with the control pad 12. The parameter information is sent to the infrared receiver 2 and is also shown on the LCD display 13. FIG. 3 is a schematic circuit diagram for the infrared receiver 2, the brightness sensor 3, and the brightness controller 4. The brightness sensor 3 is placed at a reference place to sense the brightness for reference. The brightness controller 4 is a CPU 41 that receives parameter information from the infrared controller 1 and the brightness for reference from brightness sensor 3 and sends out signal to the DC voltage controller 5. In automatic control mode, the CPU 41 for brightness control makes comparison between the parameter set by the infrared controller 1 and the brightness sensed by the brightness sensor 3. When the brightness sensed by the brightness sensor 3 is higher than the parameter set by the infrared controller 1, the CPU 41 for brightness control will then sends out signal to the DC voltage controller 5 to lower the output voltage to the LED lighting device 6 and so to lower the brightness of the LED lighting device 6. On the other hand, when the brightness sensed by the brightness sensor 3 is lower than the parameter set by the infrared controller 1, the CPU 41 for brightness control will then sends out signal to the DC voltage controller 5 to raise the output voltage to the LED lighting device 6 and so to raise the brightness of the LED lighting device 6. For manual remote control, the CPU 41 for the brightness control will only use the parameter from the infrared controller 1 to send out signal to the DC voltage controller 5 to adjust the output voltage of the DC voltage controller 5. The brightness of the LED lighting device 6 will then be adjusted accordingly.

FIG. 4 is a schematic circuit diagram for the DC voltage controller 5. The DC voltage controller 5 receives DC input voltage (DC V IN) from DC power supply and sends out DC output voltage (DC V OUT) controlled by the brightness controller. The DC voltage controller 5 can adjust the DC output voltage manually or automatically. For automatic control, the voltage control IC 51 receives the voltage control signal (DC V CS) from the brightness controller 4 and automatically adjusts the output voltage accordingly. One can also adjust the potential meter 52 manually to adjust the output voltage.

The infrared controller 1 sets the required parameter and sends the parameter to the infrared receiver 2. The infrared receiver 2 then forwards the parameter to the brightness controller 4. The communication between the infrared controller 1 and the infrared receiver 2 can be with wire or wireless. With the infrared controller 1 one can control the brightness controller 4 through the infrared receiver 2 remotely.

The brightness sensor 3 is placed in a position to sense the brightness at that position as reference brightness. The brightness data at that position is automatically transmitted to the brightness controller 4.

There are two brightness control modes, namely manual mode and automatic mode. At automatic mode, one can set the parameter of reference brightness needed on the infrared controller 1 and this parameter is sent to the brightness controller 4 through the infrared receiver 2. The brightness controller 4 compares the sensed data from the brightness sensor 3 and the parameter set by the infrared controller 1. When the brightness sensed by the brightness sensor 3 is higher than the parameter of reference brightness, the brightness controller 4 will automatically send signal to the DC voltage controller 5 to lower the output voltage. On the other hand, when the brightness sensed by the brightness sensor 3 is lower than the parameter of reference brightness, the brightness controller 4 will automatically send signal to the DC voltage controller 5 to raise the output voltage to the LED lighting device 6. At manual mode, irrespective of the brightness sensed by the brightness sensor 3, one can set the parameter of brightness wanted on the infrared controller 1. The infrared controller 1 transmits the information to the brightness controller 4 through the infrared receiver 2. The brightness controller 4 will then only use the manual setting parameter of brightness on the infrared controller 1 to control the output voltage to the LED lighting device 6 accordingly. Therefore the brightness of the LED lighting device can be changed instantaneously or at preset time or times.

The scope of the present invention depends only upon the following claims, and is not limited by the above embodiment.

What is claimed is:

1. A brightness control system for LED lighting device, an AC/DC converter is used to convert an AC power to a DC power for the LED lighting device, the brightness control system comprising:
an infrared controller, which is used for setting parameter and sending the parameter to the infrared receiver stated below;
an infrared receiver, which transfers the parameter to the brightness controller stated below;
a brightness sensor, which senses brightness at a place where the brightness sensor is placed and sends the brightness to the brightness controller stated below;
a brightness controller, which sends a signal to the DC voltage controller stated below to adjust an output voltage of the DC voltage controller automatically according to the brightness received from the brightness sensor and the parameter from the infrared controller through the infrared receiver;
a DC voltage controller, which receives the DC power from the AC/DC converter and sends out the output voltage controlled by the brightness controller to the LED lighting device.

2. A brightness control system for LED lighting device, an AC/DC converter is used to convert an AC power to a DC power for the LED lighting device, the brightness control system comprising:
an infrared controller, which is used for setting parameter and sending the parameter to the infrared receiver stated below;
an infrared receiver, which transfers the parameter to the brightness controller stated below;
a brightness controller, which sends a signal to the DC voltage controller stated below to adjust an output voltage of the DC voltage controller according to the parameter from the infrared controller through the infrared receiver;
a DC voltage controller, which receives the DC power from the AC/DC converter and sends out the output voltage controlled by the brightness controller to the LED lighting device.

3. The brightness control system for LED lighting device according to claims 1 or 2, wherein the output voltage of the DC voltage controller can be manually adjusted by a potential meter in the DC voltage controller.

4. The brightness control system for LED lighting device according to claims 1 or 2, wherein communication between the infrared controller and the infrared receiver can be with wire or wireless.
